(19) United States
(12) Patent Application Publication
(10) Pub. No.: US 2026/0202664 A1
(43) Pub. Date: Jul. 16, 2026

(54) Zooming Autocollimator with Real-Time Line-of-Sight Alignment Correction

(71) Applicant: Oren Aharon, Nesher (IL)

(72) Inventor: Oren Aharon, Nesher (IL)

(21) Appl. No.: 19/017,669

(22) Filed: Jan. 12, 2025

(51) Int. Cl. G02B 27/00; G01B 11/26; G02B 27/30

(52) U.S. Cl. CPC G02B 27/0025; G01B 11/26; G02B 27/30

(57) ABSTRACT

The electronic autocollimator is a high-precision angle measurement device, limited by its narrow field of view, which restricts usability. This patent introduces a novel autocollimator incorporating a zooming lens to expand the field of view significantly. However, mechanical adjustments required for zooming can introduce line-of-sight deviations, compromising measurement accuracy. To address this, the design employs a reference cross projected from the autocollimator onto a stationary reflective system, providing real-time correction for mechanical misalignment. This innovative approach ensures continuous line-of-sight attitude adjustment, enhancing performance and maintaining precision while utilizing zooming capabilities.

### BACKGROUND OF THE INVENTION

### 1. Field of the Invention

The pertinent art involves high-precision optical measurement devices, specifically autocollimators. A person skilled in this field would have expertise in:
Optical design principles.
Angular measurement techniques.
Mechanical alignment correction methods.

Such a person would recognize the challenges posed by field-of-view expansion and mechanical misalignment but may not readily conceive the integration of a zooming lens with real-time alignment correction as disclosed in the proposed invention.

The absence of autocollimators with zooming lenses stems from the challenge of maintaining a highly accurate line of sight during zooming, which was previously deemed unfeasible. A zooming autocollimator would offer significant advantages, such as a wide field of view for general observation and high precision with a narrower field of view for detailed measurements. Our innovation provides a groundbreaking solution by enabling real-time measurement of line-of-sight deviations caused by zooming and continuously correcting these deviations, ensuring precise and error-free measurements.

### 2. Description of the Related Art

Digital autocollimators are precision instruments designed to measure small angular displacements with high accuracy. They use electronic sensors, such as CCD or CMOS, to detect reflected light beams from a target, enabling fast, precise, and non-contact measurements. These devices are widely used in applications requiring alignment, angular measurement, and calibration, offering advantages such as real-time digital output, compact designs, and integration with modern data processing systems.

For example, the following patents dealing with autocollimation art were examined as follows:
1. U.S. Pat No. 3,087,377 (Daley)—Polarized Light Autocollimator

This patent describes an autocollimator utilizing polarized light for precise angular measurements. While effective for specific applications, its design lacks the capability to significantly expand the field of view, as required for broader usability.
2. U.S. Pat. No. 11,204,234 B1 (Heideman)—High-Speed Wide-Field Autocollimator

Heideman's system addresses high-speed measurements over a wide field of view. However, it does not incorporate mechanisms to mitigate mechanical misalignments introduced by adjustable components, leaving measurement accuracy vulnerable.
3. US 2010/0309482 A1 (Oikaze)—Surface Shape Measurement Apparatus and Method

Oikaze focuses on surface shape measurements rather than angular precision. The method does not address line-of-sight deviations caused by mechanical adjustments, making it unsuitable for applications requiring precise angular corrections.
4. U.S. 3,316,799 (Daley)—Two-Axis Autocollimator Using Polarized Light

This invention extends the functionality of polarized light-based autocollimators to two-axis measurements. While offering enhanced versatility, it does not propose a solution for maintaining line-of-sight alignment during zooming operations.

### Ascertaining the Differences Between the Prior Art and the Proposed Invention

The proposed invention differentiates itself from the prior art by addressing a critical limitation in conventional autocollimators: the inability to maintain measurement accuracy during zooming. Unlike existing designs:
It incorporates a zooming lens to significantly expand the field of view.
It employs a reference cross projected onto a stationary reflective system, enabling real-time correction for mechanical misalignment during zooming.
This approach ensures continuous line-of-sight attitude adjustment, enhancing precision and performance beyond what is achieved by the prior art.

Objective evidence supporting the nonobviousness of the proposed invention includes:
The novel integration of a zooming lens with a stationary reflective system for real-time correction of line-of-sight deviations.
Enhanced functionality that balances a significantly expanded field of view with precise angular measurement, which is not addressed by the prior art.
Improved usability in applications requiring both high precision and adaptable field-of-view capabilities, a feature absent in existing solutions.
Real-time correction of the autocollimator's measurements is achieved by utilizing information from a stationary reflective system. This system operates by projecting the autocollimator's reference cross at a wavelength different from the illumination wavelength used to generate the digital autocollimator data. In conclusion, the proposed invention introduces innovative advancements that overcome the limitations of prior art, demonstrating a nonobvious and inventive step in the field of autocollimators.

### SUMMARY

This patent introduces a groundbreaking innovation in high-precision angular measurement through a zooming autocollimator equipped with a real-time line-of-sight alignment correction mechanism. Traditional autocollimators are limited by their narrow field of view, which restricts their versatility. The proposed invention addresses this limitation by incorporating a zooming lens that expands the field of view, while maintaining measurement precision.

The challenge with zooming lenses in such devices is that mechanical adjustments required for zooming can introduce line-of-sight deviations, affecting accuracy. To overcome this, the design uses a reference cross projected onto a stationary reflective system, which continuously adjusts the line-of-sight attitude in real-time, compensating for any misalignment caused by mechanical zooming adjustments. This ensures precise and error-free measurements, even when switching between wide and narrow fields of view.

The invention enhances usability by providing both a broad field of view for general observation and high precision for detailed measurements, all while ensuring the maintenance of alignment during zooming operations. The integration of a zooming lens with real-time correction for mechanical misalignment is a novel and non-obvious feature, setting this invention apart from existing solutions in the field of autocollimators.

The invention relates to a zooming autocollimator system and method designed for high-precision angular measurements. The system includes a zooming lens assembly to adjust the field of view, a reference cross generator for projecting a reference pattern, a stationary reflective system to reflect the reference cross back into the autocollimator, and a real-time alignment correction mechanism to detect and compensate for line-of-sight deviations introduced during zoom operations. The zooming lens assembly enables transitions between wide and narrow fields of view for varied measurement precision, while a detector array analyzes the reflected reference cross to compute alignment corrections. The reference cross generator operates at a wavelength distinct from the measurement illumination wavelength, allowing independent correction processes. A computational processor analyzes misalignments caused by zooming and implements real-time corrections to maintain accuracy, aided by stable reflective elements like mirrors or prisms. The system also features an angular measurement output for providing corrected angular displacement readings and supports integration into optical devices for alignment, calibration, and precision measurement. A corresponding method includes zoom adjustment, reference cross projection, deviation detection, real-time correction, and output of corrected angular data, with compensation for mechanical misalignments and distinct-wavelength operations enhancing overall functionality.

### BRIEF DESCRIPTION OF THE DRAWINGS

FIG. 1 is a schematic representation of an optical system for an autocollimator instrument.

FIG. 2 illustrates a zooming autocollimator with a reference cross projected using three illumination sources.

FIG. 3 shows the zooming autocollimator using the reference cross reflected by the stationary dichroic mirror.

FIG. 4 shows the zooming autocollimator in a different zooming position creating an objective lens with different focal length.

FIG. 5 is GUI representation describing the misalignment between the original cross position and the reflected cross from the dichroic mirror.

FIG. 6 is an image describing the situation after the misalignment difference was corrected.

### DETAILED DESCRIPTION OF THE DRAWINGS

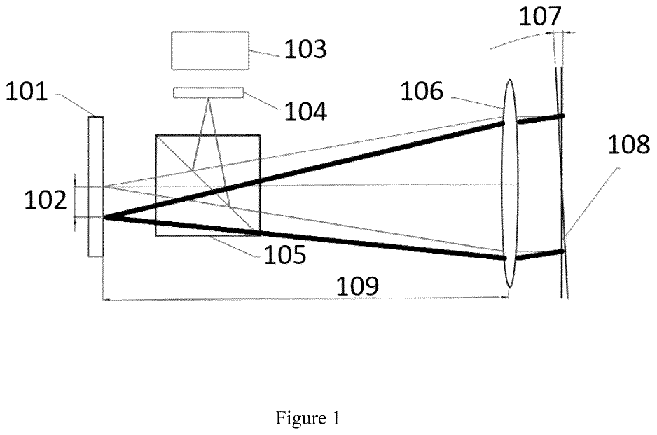

FIG. 1 illustrates a classical autocollimator. A light source (103) projects light through a cross-shaped reticle (104). While classical autocollimators typically use white light, this application utilizes a three-color light source. By controlling the current input for each LED, different colors can be projected as needed. The light passes through a beam splitter (105) and an objective lens (106) before being reflected by a mirror (107). Any minor angular deviation of the mirror (108) causes the reflected beam to focus on a detector (101), with its displacement on the detector surface (102) directly proportional to the angular deviation. For accuracy, the lens is positioned precisely one focal length from the detector, and the system is constructed to prevent focal length (109) changes caused by mechanical variations.

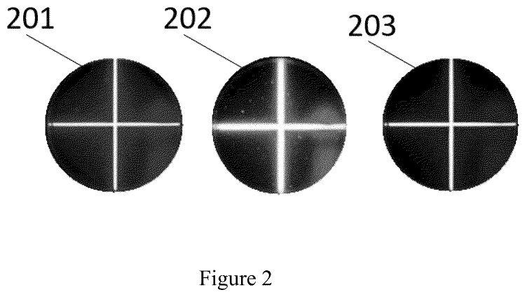

FIG. 2 depicts the projected light emerging from the autocollimator's objective lens (106). A computer-controlled switching mechanism enables color changes by selectively powering LEDs. The illustration shows a red cross (201) activated by the red LED. Switching to the second or third LED projects green (202) or another color (203). The software allows single-color projection or multi-wavelength illumination resembling white light.

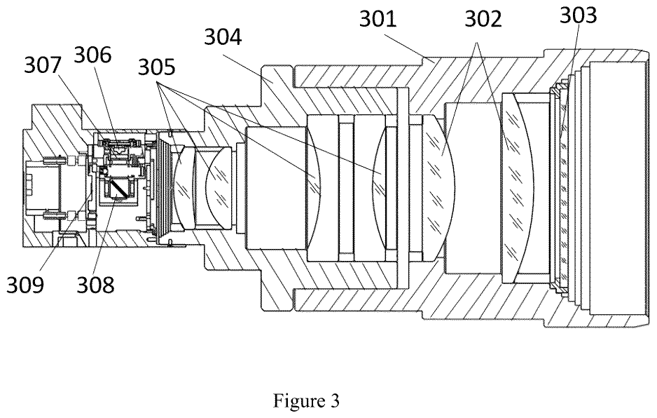

FIG. 3 shows an enhanced autocollimator where the objective lens is replaced with a multi-lens zoom assembly, allowing focal length adjustment. This modification enables a flexible field of view to accommodate diverse laboratory needs. The zoom assembly consists of two groups: a stationary group (301) with two lenses (302) and a moving group (304) with lenses (305). A dichroic filter (303) reflects one projected color while transmitting others. The light source (306) and reticle (307) remain constant. The system's ray tracing resembles that of a standard autocollimator, and the reflected cross is captured by a camera (309). During boresight correction, light reflected by the filter (303) creates a reference cross on the detector. Software algorithms align this cross with the autocollimator's original center for correction.

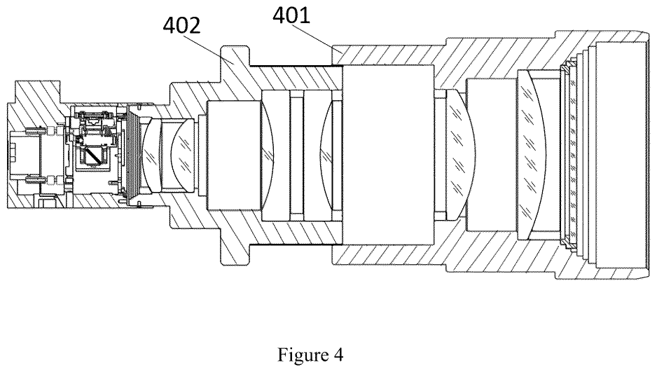

FIG. 4 illustrates the zooming action. The stationary lens group (401) remains fixed, while the movable group adjusts the focal length by creating a variable gap. The reflected light from the dichroic filter (303) establishes a reference position for further corrections.

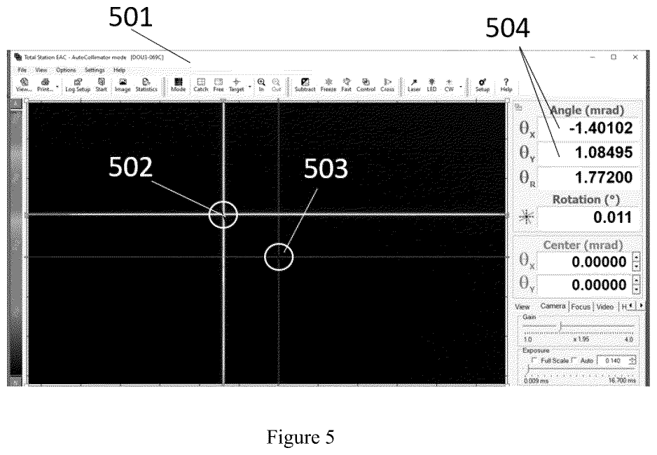

FIG. 5 shows a processed image from the autocollimator's sensor (309). The reflected reference cross (502) is displayed on the software interface (501), along with its deviation (503) and the computed value (504).

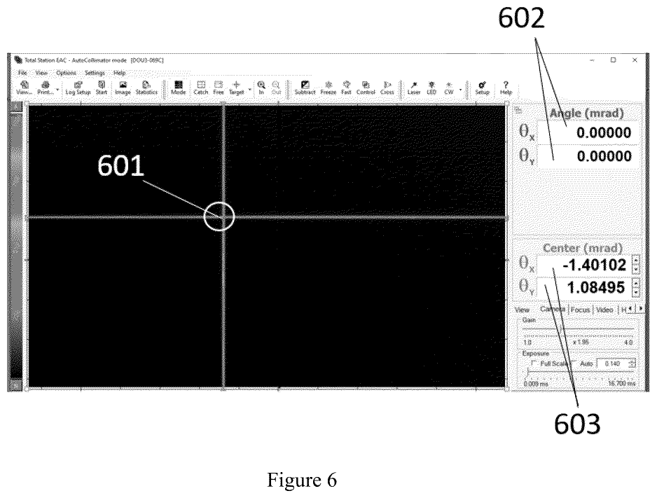

FIG. 6 demonstrates post-correction results, where the reference cross (502) aligns with the center (503), eliminating deviations. The corrected cross (601) and deviation value (602) of 0.0 are displayed alongside the correction value (603) in milliradians, which is stored for subsequent measurements at the same focal length.

What is claimed is:

1. An autocollimator system for high-precision angular measurements, comprising:
a zooming lens assembly configured to adjust the field of view of the autocollimator;
a reference cross generator for projecting a reference pattern;
a stationary reflective system designed to reflect the reference cross back into the autocollimator; and
a real-time alignment correction mechanism that detects and compensates for line-of-sight deviations introduced by zooming operations to maintain measurement accuracy.

2. The system of claim 1, wherein the zooming lens assembly provides a transition between a wide field of view for general observations and a narrow field of view for detailed, high-precision measurements.

3. The system of claim 1, wherein the real-time alignment correction mechanism includes a detector array for analyzing the reflected reference cross and computing adjustments for line-of-sight deviations.

4. The system of claim 1, wherein the reference cross generator operates at a wavelength distinct from the measurement illumination wavelength, enabling independent detection and correction processes.

5. The system of claim 1, further comprising a computational processor configured to:
analyze data from the stationary reflective system,
determine the extent of mechanical misalignment caused by zooming operations, and
implement corrections to realign the line of sight in real time.

6. The system of claim 1, wherein the stationary reflective system comprises a mirror or prism designed to maintain high reflectivity and positional stability.

7. The system of claim 1, wherein the zooming lens assembly is mechanically adjustable, and the alignment correction mechanism compensates for misalignments caused by such adjustments.

8. The system of claim 1, further comprising an angular measurement output module configured to provide real-time corrected angular displacement readings.

9. The system of claim 1, wherein the zooming autocollimator is integrated into an optical measurement device for applications including alignment, calibration, and angular displacement measurement.

10. A method for high-precision angular measurements using a zooming autocollimator, comprising:
adjusting a zooming lens to modify the field of view;
projecting a reference cross onto a stationary reflective system;
detecting the reflected reference cross to measure line-of-sight deviations;
applying real-time corrections to maintain alignment; and
outputting corrected angular displacement data.

11. The method of claim 10, wherein adjusting the zooming lens enables a transition between a wide field of view for general observations and a narrow field of view for precise measurements.

12. The method of claim 10, wherein the corrections are computed based on deviations detected by a sensor array analyzing the reflected reference cross.

13. The method of claim 10, wherein the reference cross is generated using a light source operating at a wavelength distinct from the measurement wavelength, allowing simultaneous measurement and correction processes.

14. The method of claim 10, further comprising compensating for mechanical misalignments caused by zooming operations using data processed by a computational module.
